(19) United States
(12) Patent Application Publication
(10) Pub. No.: US 2015/0036232 A1
(43) Pub. Date: Feb. 5, 2015

(54) MULTI-LAYER OPTICAL COMPONENTS AND METHOD FOR FABRICATING SAME

(71) Applicant: Suzhou Synta Optical Technology Co., Ltd., Suzhou (CN)

(72) Inventor: Dar-Tson SHEN, West Vancouver (CA)

(21) Appl. No.: 14/448,101

(22) Filed: Jul. 31, 2014

Related U.S. Application Data
(60) Provisional application No. 61/861,505, filed on Aug. 2, 2013.

(51) Int. Cl. G02B 5/08; G02B 7/183

(52) U.S. Cl. CPC G02B 5/0816; G02B 7/183
USPC 359/848; 29/428

(57) ABSTRACT

A multi-layer mirror comprising a front plate, a backing plate and spacers coupled between the front plate and the backing plate. The spacers are closely packed with one another and arranged in a manner where adjacent spacers contact one another and packing spaces are defined between groups of spacers in contact with one another. Each of the spacers comprises a plurality of ventilation holes extending between a bore of the spacer and an exterior of the spacer. For each spacer, the plurality of ventilation holes comprises a first ventilation hole in fluid communication with a first packing space defined at least in part by the spacer and a second ventilation hole, spaced apart from the first ventilation hole and in fluid communication with a second packing space defined at least in part by the spacer.

### TECHNICAL FIELD

This invention relates to glass components, such as mirrors and the like and to fabrication of same. Particular embodiments provide apparatus and methods for fabricating large, lightweight mirrors.

### BACKGROUND

There is a desire to use large mirrors in telescopes and other optical instruments, since relatively large mirrors may be capable of gathering and using relatively large amounts of light. The use of large, lightweight mirrors for astronomical telescopes and other optical systems is known in the art.

Historically, large mirrors used for astronomical applications have been manufactured from large monolithic blanks of glass with reflecting surfaces supported by relatively thick substrates to help to maintain the shape of the reflecting surfaces both during and after fabrication. Typically, glass thickness ranges from about one tenth to one sixth of the mirror diameter. Large mirrors fabricated in this manner are typically heavy and are also typically expensive to manufacture due to high material costs.

Techniques have since been disclosed for producing large mirrors that are purportedly relatively lightweight compared to their earlier counterparts. A number of such techniques include those disclosed in:
UK patent No. 968025;
U.S. Pat. No. 3,507,737;
U.S. Pat. No. 3,644,022;
U.S. Pat. No. 4,447,130;
U.S. Pat. No. 2,988,959;
U.S. Pat. No. 5,076,700; and
US patent publication No. 2008/0043352.

Despite work that has been done to manufacture lightweight mirrors for use in astronomical and optical purposes, there remains a need for practical and cost effective lightweight mirrors and methods of manufacturing same.

### SUMMARY

The invention has several aspects. One aspect of the invention provides a multi-layer optical component. The optical component comprises: a front plate; a backing plate; and a plurality of spacers extending between the front plate and the backing plate to maintain a space therebetween, the spacers arranged in a closely packed arrangement where each spacer is in contact with at least one neighboring spacer. Each spacer comprises a bore-defining surface which defines a bore that extends through the spacer and between the front plate and the backing plate. Each spacer provided with a plurality of spaced apart ventilation holes for providing fluid communication between the bore of the spacer and a location exterior to the bore of the spacer.

Another aspect of the invention provides a method for fabricating a multi-layer optical component, the method comprising: providing a front plate; providing a backing plate; locating a plurality of spacers to extend between the front plate and the backing plate for maintaining a spacer therebetween; arranging the spacers in a closely packed arrangement where each spacer is in contact with at least one neighboring spacer; providing each spacer with a bore that extends through the spacer and between the front plate and the backing plate; and providing each spacer with a plurality of spaced apart ventilation holes for providing fluid communication between the bore of the spacer and a location exterior to the bore of the spacer.

Another aspect provides multi-layer mirror comprising a front plate, a backing plate and spacers coupled between the front plate and the backing plate. The spacers are closely packed with one another and arranged in a manner where adjacent spacers contact one another and packing spaces are defined between groups of spacers in contact with one another. Each of the spacers comprises a plurality of ventilation holes extending between a bore of the spacer and an exterior of the spacer. For each spacer, the plurality of ventilation holes comprises a first ventilation hole in fluid communication with a first packing space defined at least in part by the spacer and a second ventilation hole, spaced apart from the first ventilation hole and in fluid communication with a second packing space defined at least in part by the spacer. The plurality of holes may be three or more holes. The spacers may have different cross sectional shapes. In some embodiments, for each of the spacers, each of the one or more ventilation holes may be defined in part by a rim of the spacer and in part by the front plate or the backing plate or may be identified entirely by the body of the spacer. Some of the spacers located on the periphery of the mirror have at least one ventilation hole in fluid communication with a packing space defined in part by the spacer and a at least one other ventilation hole spaced apart from the first ventilation hole and is in communication with the space exterior to the mirror. The front plate, the backing plate and the spacers may be made from the same material or from different material and they may be coupled together by different means such as gluing, wilding or fusing.

Another aspect of the invention provides a multi-layer mirror comprising a front plate, a backing plate and spacers coupled between the front plate and the backing plate. The spacers are closely packed with one another and shaped and arranged in a manner where adjacent spacers contact one another and there is no packing space between the front plate and the backing plate. Each spacer comprises a plurality of ventilation holes extending between a bore of the spacer and an exterior of the spacer. For each spacer, the plurality of ventilation holes comprises a first ventilation hole in fluid communication with a first adjacent ventilation hole of a first adjacent spacer and a second ventilation hole spaced apart from the first ventilation hole and in fluid communication with a second adjacent ventilation hole of a second adjacent spacer. Some of the spacers located on the periphery of the mirror have at least one ventilation hole in fluid communication with a ventilation hole from an adjacent spacer and at least one ventilation hole in fluid communication with the space exterior to the mirror.

Another aspect of the invention provides a method for fabrication a multi-layer mirror, the method comprises the steps of providing a front plate, a backing plate and spacers where each of the spacers has a plurality of ventilation holes extending between a bore of the spacer and an exterior of the spacer. The method also involves positioning the spacers in a closely packed configuration with one another and in engagement with the front plate and the backing plate. In this step, the spacers are arranged in a manner where adjacent spacers contact one another and packing spaces are defined between groups of spacers in contact with one another. The plurality of ventilation holes in each of the spacers comprises a first ventilation hole in fluid communication with a first packing space defined at least in part by the spacer and a second ventilation hole, spaced apart from the first ventilation hole and in fluid communication with a second packing space defined at least in part by the spacer. In case of spacers located at the periphery of the mirror, the second ventilation holes may be in fluid communication with the space exterior to the mirror. The method also includes joining the front plate, the backing plate and the spacers into a unitary structure and forming the unitary structure into a predetermined mirror configuration.

Another aspect of the invention provides a method for fabrication a multi-layer mirror, the method comprises the steps of providing a front plate, a backing plate and spacers, where each of the spacers has plurality of ventilation holes extending between a bore of the spacer and an exterior of the spacer. The method also includes positioning the spacers in a closely packed configuration with one another and in engagement with the front plate and the backing plate. In this step the spacers are arranged in a manner where adjacent spacers contact one another and no packing spaces are defined between groups of spacers in contact with one another. The plurality of ventilation holes in each of the spacers comprises a first ventilation hole in fluid communication with a first adjacent ventilation hole of a first adjacent spacer and a second ventilation hole spaced apart from the first ventilation hole and in fluid communication with a second adjacent ventilation hole of a second adjacent spacer. In case of spacers located at the periphery of the mirror, the second ventilation holes may be in fluid communication with the space exterior to the mirror. The method also involves the steps of joining the front plate, the backing plate and the spacers into a unitary structure and forming the unitary structure into a predetermined mirror configuration.

### BRIEF DESCRIPTION OF THE DRAWINGS

The accompanying drawings illustrate non-limiting example embodiments of the invention.

FIG. 1 shows an isometric view of a multi-layer optical component according to an embodiment of the invention.

FIG. 2 shows a partial isometric view of the FIG. 1 optical component depicting a single spacer in isolation.

FIG. 3 is a partial exploded isometric view of the FIG. 1 optical component depicting a single spacer in isolation.

FIGS. 4A and 4B show a schematic illustration of an exemplary molding process which may be used to fabricate a multi-layer optical component according to another embodiment of the invention.

FIG. 5 is a partial plan view of the FIG. 1 optical component with the front plate removed to show the spacer arrangement.

FIG. 6 shows a partial plan view of an optical component according to another embodiment with the front plate removed to show the spacer arrangement.

FIG. 7 shows a partial plan view of an optical component according to another embodiment with the front plate removed to show the spacer arrangement.

### DESCRIPTION

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

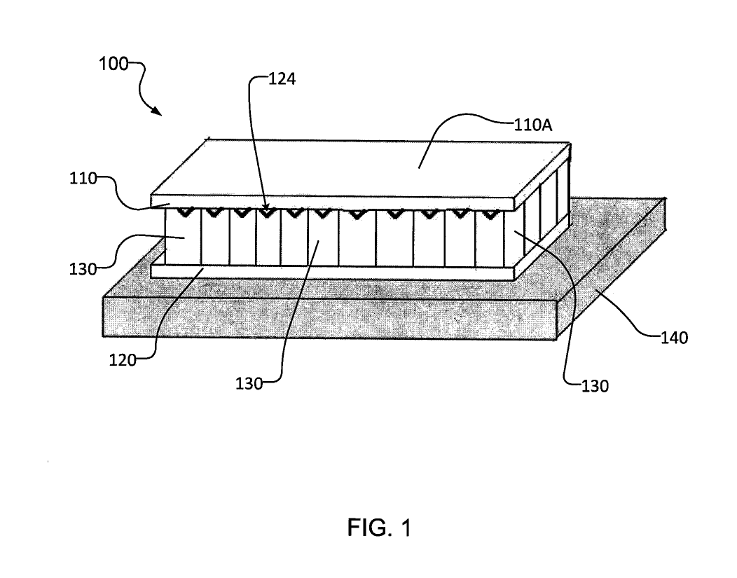

FIG. 1 shows an isometric view of a multi-layer optical component (e.g. a mirror) 100 according to an embodiment of the invention. Optical component 100 comprises a front plate 110 having an outer surface 110A, a backing plate 120 and a plurality of spacers 130 disposed between front plate 110 and backing plate 120. In the exemplary FIG. 1 embodiment, optical component 100 is a mirror 100, front plate 110 comprises an optical plate 110 and outer surface 110A of optical plate 110 comprises a reflective mirror surface 110A. In other embodiments, optical component 100 may comprise a different type of optical component, such as, without limitation: a window, a prism, a lens and/or the like. In the description that follows, optical component 100 may be referred to as mirror 100, front plate 110 may be referred to as optical plate 110 and outer surface 110A of front plate 110 may be referred to as mirror surface 110A without loss of generality.

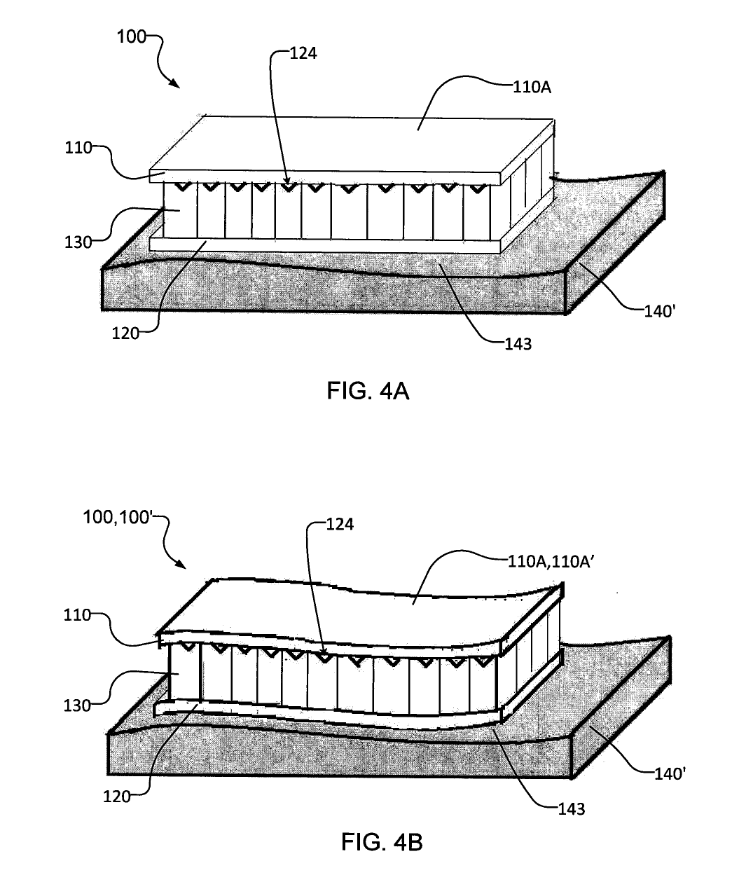

In the FIG. 1 embodiment, each of front plate 110 and backing plate 120 has a rectangular perimeter shape. In some embodiments, front plate 110 and/or backing plate 120 may be provided with other suitable perimeter shapes (e.g. circular, elliptical and/or the like). In the FIG. 1 embodiment, mirror surface 110A is generally planar. In some embodiments, mirror surface 110A may be curved as desired (see description of FIGS. 4A and 4B below). In the FIG. 1 embodiment, front plate 110 and backing plate 120 are both cuboid in shape. This is not necessary. Front plate 110 and backing plate 120 may have other suitable three-dimensional shapes. In some embodiments, front plate 110 and backing plate 120 may have thicknesses t in a range of 2 mm-50 mm. In some embodiments, this range is 8 mm-20 mm. This thickness t may depend on the dimensions of the bores 122 of spacers 130, with smaller bores 122 permitting the use of thinner plates 110, 120. In some embodiments, the shapes of front plate 110 and backing plate 120 may be different than one another.

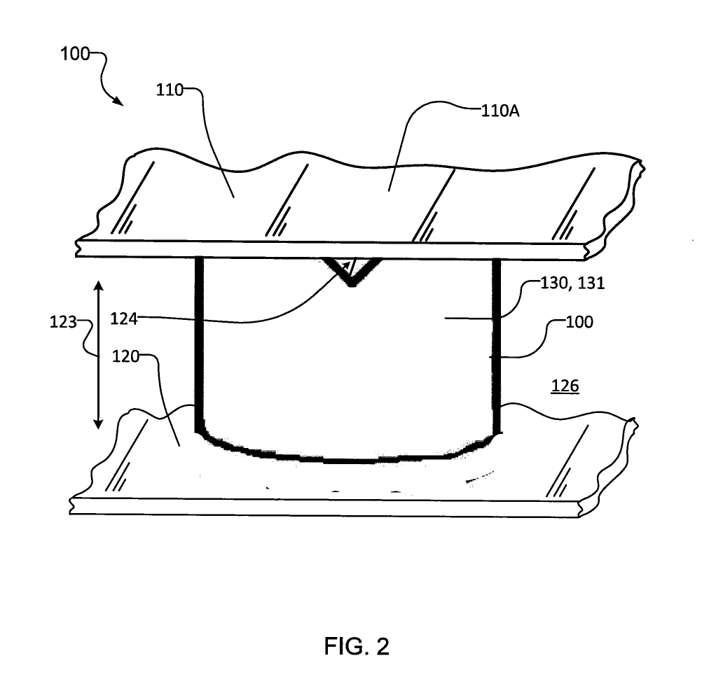

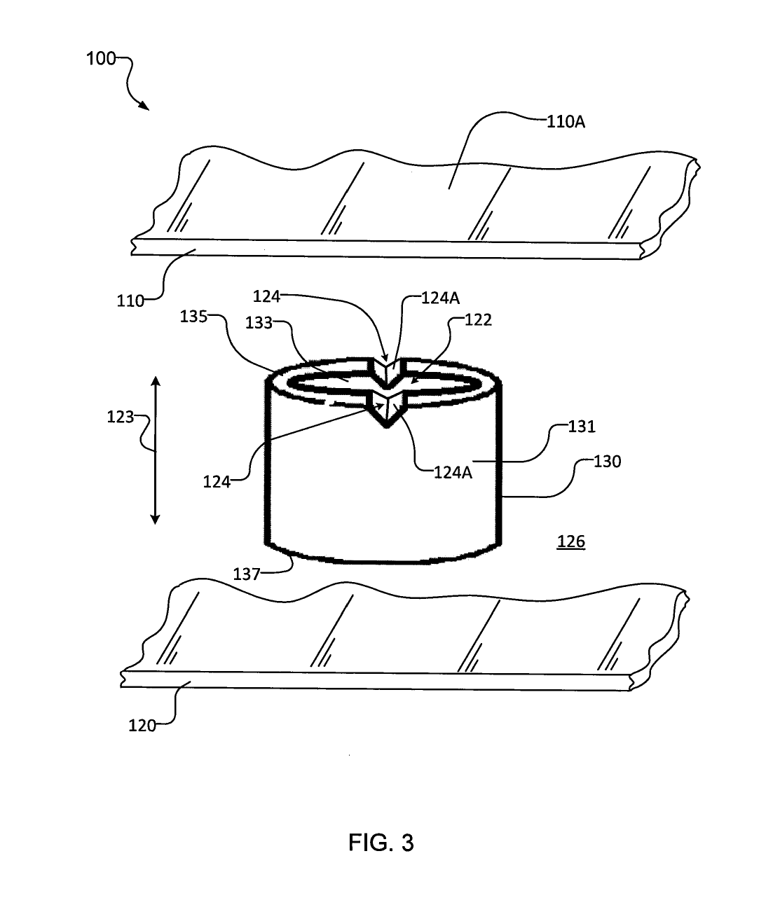

Optical component 100 comprises a plurality of spacers 130 which are located between front plate 110 and backing plate 120. Additional detail of an individual spacer 130 is shown in the partial views of FIGS. 2 and 3. Spacers 130 are tubular shaped to define bores 122 that extend therethrough along axial dimensions indicated by double headed arrow 123 (FIGS. 2 and 3). In the illustrated embodiment of FIGS. 1-3, the outer surfaces 131 of spacers 130 are circular in transverse cross-section (i.e. in a cross-section taken across axial dimension 123). In some embodiments, the outer surfaces 131 of spacers 130 could additionally or alternatively have other suitable transverse cross-sectional dimensions—e.g. polygonal, oval, elliptical and/or the like. In the illustrated embodiment of FIGS. 1-3, the inner (bore-defining) surfaces 133 of spacers 130 are generally circular in transverse cross-section to provide bores 122 with circular transverse cross-sections. This is not necessary. In some embodiments, bore-defining surfaces 133 of spacers 130 could have other additional or alternative transverse cross-sections, which may be the same as or different from the transverse cross-sections of outer surfaces 131. In the illustrated embodiment of FIGS. 1-3, spacers 130 all have the same size and shape, but in general, spacers 130 may have different sizes and/or shapes from each other. In some embodiments, the transverse dimensions (e.g. diameter or other cross-sectional dimensions) of spacers 130 may be in a range of 10 mm-75 mm. In some embodiments, this range is 30 mm-50 mm.

Spacers 130 support front plate 110 relative to backing plate 120 (and vice versa) during fabrication, and during subsequent use, of optical component 100. The number, size and arrangement of spacers 130 may be adjusted to provide this support functionality. In some embodiments, spacers 130 are arranged so as to be closely packed with one another. In this description, the term closely packed should be understood to mean that the outer surface 131 each spacer 130 is in contact with the outer surface 131 of at least one (and typically more than one) neighboring spacer 130. In some embodiments, front surfaces 135 and back surfaces 137 of spacers 130 may be respectively welded (or otherwise fused) to front plate 110 and backing plate 120 during fabrication of optical component 100 by the application of heat (e.g. in a molding kiln or the like). In some embodiments, front surfaces 135 and back surfaces 137 of spacers 130 may be additionally or alternatively attached to front plate 110 and backing plate 120 using other suitable techniques—e.g. adhesive bonding and/or the like.

Front plate 110 (except possibly a surface layer on mirror surface 110A), backing plate 120 and spacers 130 may be fabricated from the same material, which may comprises, by way of non-limiting example: quartz glass, fused quarts, high-silica glass, borosilicate (e.g. Pyrex™) glass and/or the like. Fabricating front plate 110, backing plate 120 and spacers 130 from the same material may help to mitigate distortion which may occur during fabrication (e.g. when optical component 100 is heated in a kiln for molding and/or to promote fusing of spacers 130 to plates 110, 120) and during subsequent use. This is not necessary, however, and front plate 110, backing plate 120 and spacers 130 may be fabricated from different materials.

As alluded to above, in some embodiments, during fabrication of optical component 100, optical component 100 is subjected to heat (e.g. in a suitable kiln) or the like. This application of heat may be used to fuse front surfaces 135 of spacers 130 to front plate 110 and back surfaces 137 of spacers 130 to backing plate 120. This application of heat may also be used as part of a molding process to provide optical component 100 (or portions thereof) with desired shapes. During the application of heat, optical component 100 may be placed in (or on) a suitable mold 140 which may be used to shape optical component 100. In the FIG. 1 embodiment (where it is desired to provide mirror surface 110A with a generally planar shape), mold 140 may comprise a flat mold substrate 140 having a generally planar upper surface 141. In some embodiments, mold 140 may comprise other additional or alternative mold components (not shown) which may abut against the sides of optical component 100 and/or against outer surface 110A of front plate 110 to directly shape these surfaces. In this manner, mold 140 may comprise a three-dimensional mold 140.

When optical component 100 is subjected to heat in this manner, one or more of the surfaces of optical component 100 (including, for example, mirror surface 110A) may take a shape that is complementary to the shape of mold 140. Molds 140 with different surface shapes may be used depending on the desired shapes of the surfaces of optical component 100 (e.g. the desired shape of mirror surface 110A). In some embodiments, it may be desirable to impart a particular shape to mirror surface 110A (or to some other optically active surface of optical component 100). In the illustrated embodiment of FIG. 1, it is desired to provide mirror surface 110A with a generally planar profile. Consequently, mold 140 comprises a generally planar upper surface 141. As discussed above, in some embodiments, mold 140 may comprise other additional or alternative mold components (not shown) which may abut against the sides of optical component 100 and/or against outer surface 110A of front plate 110 to directly shape these surfaces. For example, mold 140 may comprise a mold component (not shown) which abuts directly against mirror surface 110A to shape mirror surface 110A.

FIGS. 4A and 4B schematically depict a process for molding optical component 100 (and in particular mirror surface 110A) to provide a molded (e.g. curved) optical component 100′ having a curved mirror surface 110A′. As shown in FIGS. 4A and 4B, optical component 100 is placed in (or on) a suitable mold 140′ having a curved surface 143 which abuts against a corresponding surface of optical component 100 (e.g. against backing plate 120 in the case of the illustrated embodiment). Upon application of heat, optical component 100 conforms to the shape of surface 143 of mold 140′ to become molded (e.g. curved) optical component 100′, thereby providing a correspondingly curved mirror surface 110A′. Because heat is applied to optical component 100′, a mold 140′ on a single surface (of backing plate 120) may be sufficient to mold mirror surface 110A as optical component 100′ the heat causes both front plate 110 (including mirror surface 110A) and backing plate 120 to become sufficiently malleable to take the shape of surface 143 of mold 140′. As discussed above, in some embodiments, mold 140′ may comprise other additional or alternative mold components (not shown) which may abut against the sides of optical component 100 and/or against outer surface 110A of front plate 110 to directly shape these surfaces. For example, mold 140′ may comprise a mold component (not shown) which abuts directly against mirror surface 110A to shape mirror surface 110A into mirror surface 110A′.

Referring again to FIGS. 2 and 3, spacers 130 are provided with ventilation holes 124 which extend between their bores 122 and their exteriors 126 (e.g. outside of their outer surfaces 131) to provide fluid communication therebetween. As explained in more detail below, ventilation holes 124 can provide ventilation pathways for air that would otherwise be trapped in bores 122 of spacers 130 during the application of heat and corresponding pressure regulation. Such ventilation and pressure regulation can in turn mitigate distortion of optical component 100 which may occur during application of heat. In some embodiments, ventilation holes 124 have cross-sectional dimensions in a range of 0.5 mm-20 mm. In some embodiments, this range is 5 mm-10 mm.

In the illustrated embodiment, ventilation holes 124 are defined in part by front surfaces 135 of spacers 130 and in part by front plate 110. More particularly, front surfaces 135 of spacers 130 are provided with concavities 124A which define a portion of ventilation holes 124 when front surfaces 135 of spacers 130 are attached to front plate 110. In some embodiments, back surfaces 137 may be provided with similar concavities (not shown) which may be used to provide additional or alternative ventilation holes defined in part by back surfaces 137 of spacers 130 and in part by backing plate 120. In some embodiments, additional or alternative ventilation holes 124 may be defined entirely by the body of spacers 130 (e.g. ventilation holes 124 may be drilled through spacers 130). Providing ventilation holes 124 which are defined in part by concavities (e.g. concavities 124A) in front surfaces 135 and/or back surfaces 137 of spacers 130 and in part by front plate 110 and/or back plate 120 may provide the advantage that such ventilation holes 124 are easier and/or more efficient to fabricate. For example, drilling ventilation holes 124 through spacers 130 may be time consuming and may result in breakage which may reduce production efficiency. In contrast, concavities 124A (and/or similar concavities on back surfaces 137) may be directly fabricated during molding of spacers 130.

In the FIG. 2 embodiment, spacer 130 is provided with a pair of ventilation holes 124 which are located opposite one another around a perimeter of front surface 135 of spacer 130. In other embodiments, spacer 130 may be provided with different numbers of ventilation holes 124 and such ventilation holes 124 may have different relative positions around the perimeter of spacer 130 (e.g. around front surface 135, around back surface 137 and/or around outer surface 131). In some embodiments, spacer 130 may be provided with a plurality of holes 124 and such plurality of holes 124 may include any combination of holes 124 defined entirely by the body of spacer 130, holes 124 defined the combination of front surface 135 of spacer 130 and front plate 110 and holes 124 define by back surface 137 of spacer 130 and backing plate 120.

When optical component 100 is subjected to heat (e.g. when fusing spacers 130 between front plate 110 and backing plate 120 and/or when molding optical component 100), the air inside bores 122 of spacers 130 expands. Ventilation holes 124 allow for fluid communication between bores 122 of spacers 130 and the exteriors 126 of spacers 130, which in turn allows for the expanded air to escape bores 122 during the heating process. This fluid communication regulates the pressure between bores 122 of spacers 130 and exteriors 126 of spacers 130 and consequently can be used to mitigate unwanted deformation of front plate 110, backing plate 120 and spacers 130 which may otherwise occur due to pressure buildup in bores 122. Ultimately, this pressure regulation can help to ensure that mirror surface 110A (or any other portion of optical component 100) achieves its desired shape and is relatively free from pressure related surface imperfections.

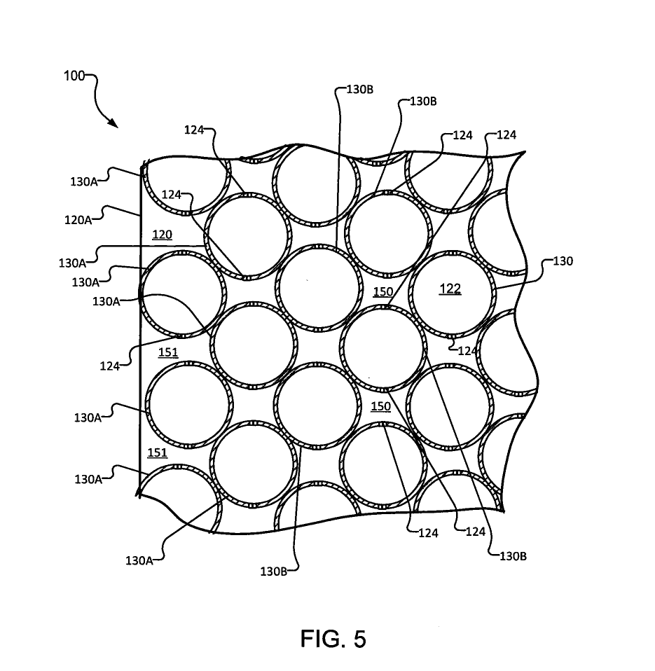

As discussed briefly above, in particular embodiments, spacers 130 are closely packed with one another, such that the outer surface 131 of each spacer 130 is in contact with the outer surface 131 of at least one (and typically more than one) neighboring spacer 130. FIG. 5 is a partial plan view of optical component 100 with front plate 110 removed to show the arrangement of spacers 130 according to an example embodiment. In the FIG. 5 embodiment, spacers 130 are arranged in a closely packed configuration wherein the outer surfaces 131 of adjacent spacers 130 contact one another to define packing spaces 150. Packing spaces 150 are spatial volumes exterior to bores 122 (e.g. exterior 126 to spacers 130 (see FIG. 3)) of spacers 130, and defined by the outer surfaces 131 of spacers 130 between regions of contact between outer surfaces 131 of spacers 130 and by front plate 110 (not shown in FIG. 5) and backing plate 120. In the FIG. 5 example embodiment, the outer surfaces 131 of spacers 130 are shown to have circular transverse cross sections; however, as discussed above, the outer surfaces 131 of spacers 130 may have other additional or alternative transverse cross sectional shapes.

Where spacers 130 are arranged to define packing spaces 150 (as is the case in the illustrated embodiment of FIG. 5), ventilation holes 124 may also provide fluid pathways for venting packing spaces 150 in which trapped air might otherwise expand and cause unwanted deformation of optical component 100 during the application of heat thereto. More particularly, each spacer 130 of the FIG. 5 embodiment is provided with a plurality (e.g. 2) of spaced apart ventilation holes 124, wherein each ventilation hole 124 is located to provide fluid communication between the bore 122 of the spacer 130 and one or more of: a packing space 150; and exterior space 151 (i.e. a space 151 exterior to optical component 100). Although not explicitly shown in FIG. 5, spacers 130 of the FIG. 5 embodiment may be provided with additional or alternative ventilation holes 124 which provide fluid communication between the bore 122 of the spacers 130 and the bores 122 of adjacent spacers 130 (i.e. through the ventilation holes 124 of such adjacent spacers 130).

Spacers 130 of the FIG. 5 embodiment may include: exterior spacers 130A which are spacers 130A adjacent to exterior space 151 or which are otherwise not transversely surrounded other spacers 130 and/or packing spaces 150; and interior spacers 130B which are transversely surrounded by other spacers 130 and/or packing spaces 150. In some embodiments, exterior spacers 130A comprise a plurality of spaced apart ventilation holes 124, wherein each ventilation hole 124 is located to provide fluid communication between the bore 122 of the exterior spacer 130A and one or more of: a packing space 150; exterior space 151; and the bore 122 of an adjacent spacer 130. In some embodiments, each of exterior spacers 130A comprises at least one ventilation hole 124 which is located to provide fluid communication between the bore 122 of the exterior spacer 130A and exterior space 151. In some embodiments, at least one of exterior spacers 130A comprises at least one ventilation hole 124 which is located to provide fluid communication between the bore 122 of the at least one exterior spacer 130A and exterior space 151. In some embodiments, interior spacers 130B comprise a plurality of spaced apart ventilation holes 124, wherein each ventilation hole 124 is located to provide fluid communication between the bore 122 of the interior spacer 130B and one or more of: a packing space 150; and the bore 122 of an adjacent spacer 130. In some embodiments, each of interior spacers 130B comprises at least one ventilation hole 124 which is located to provide fluid communication between the bore 122 of the interior spacer 130B and a packing space 150. In some embodiments, spacers 130 comprise ventilation holes 124 which are located such that there is at least one ventilation hole 124 which provides fluid communication between each packing space 150 defined in optical component 100 and the bore 122 of a corresponding spacer 130.

With such an arrangement of spacers 130 and location of ventilation holes 124, optical component 100 of the FIG. 5 embodiment provides a fluid communication pathway or network (e.g. via ventilation holes 124 and via bores 122 and/or packing spaces 150) for venting the bores 122 of each spacer 130 and for venting packing spaces 150 between spacers 130 to exterior space 151. This ventilation and the accompanying pressure regulation mitigates unwanted deformation of optical component 100 when it is subjected to heat (e.g. during fabrication or otherwise).

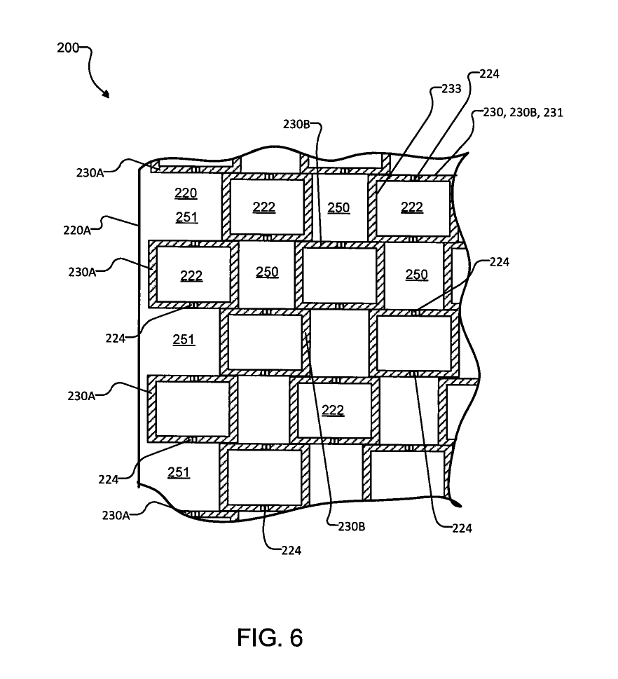

FIG. 6 is a partial plan view of optical component 200 with front plate removed to show the arrangement of spacers 230 according to an example embodiment. In many respects, optical component 200 is similar to optical component 100 described above and similar reference numbers are used to describe similar features, except that the features of optical component 200 are preceded by the numeral “2”, whereas the features of optical component 100 are preceded by the numeral “1”. Optical component 200 differs from optical component 100 primarily in that spacers 230 are polygonal in transverse cross-section. In the particular case of the embodiment illustrated in FIG. 6, spacers 230 are rectangular in transverse cross-section, although spacers may additional or alternatively be provided with other polygonal transverse cross-sections. More particularly, the outer surfaces 231 of spacers 230 are polygonal in cross-section. While, in the case of the illustrated FIG. 6 embodiment, the bore-defining surfaces 233 of spacers 230 are also polygonal in transverse cross-section, this is not necessary and, in some embodiments, the bore-defining surfaces 233 of spacers 230 may have other transverse cross-sectional shapes.

In the FIG. 6 embodiment, spacers 230 are arranged in a closely packed configuration wherein the outer surfaces 231 of adjacent spacers 230 contact one another to define packing spaces 250. Packing spaces 250 may have features similar to those of packing spaces 150 described above. As is the case with the FIG. 5 embodiment, where spacers 230 are arranged to define packing spaces 250, ventilation holes 224 may also provide fluid pathways for venting packing spaces 250 in which trapped air might otherwise expand and cause unwanted deformation of optical component 200 during the application of heat thereto. More particularly, each spacer 230 of the FIG. 6 embodiment is provided with a plurality (e.g. 2) of spaced apart ventilation holes 224, wherein each ventilation hole 224 is located to provide fluid communication between the bore 222 of the spacer 230 and one or more of: a packing space 250; and exterior space 251 (i.e. a space 251 exterior to optical component 200). Although not explicitly shown in FIG. 6, spacers 230 of the FIG. 6 embodiment may be provided with additional or alternative ventilation holes 224 which provide fluid communication between the bore 222 of the spacers 230 and the bores 222 of adjacent spacers 230 (i.e. through the ventilation holes 224 of such adjacent spacers 230).

Like spacers 130 of the FIG. 5 embodiment, spacers 230 of the FIG. 6 embodiment may comprise exterior spacers 230A and interior spacers 230B. Exterior spacers 230A and interior spacers 230B of optical component 200 may have characteristics similar to exterior spacers 130A and interior spacers 130B of optical component 100 described above and may have relative ventilation holes 224 locations similar to those of exterior spacers 130A and interior spacers 130B of optical component 100 described above. With such an arrangement of spacers 230 and location of ventilation holes 224, optical component 200 of the FIG. 6 embodiment provides a fluid communication pathway or network (e.g. via ventilation holes 224 and via bores 222 and/or packing spaces 250) for venting the bores 222 of each spacer 230 and for venting packing spaces 250 between spacers 230 to exterior space 251.

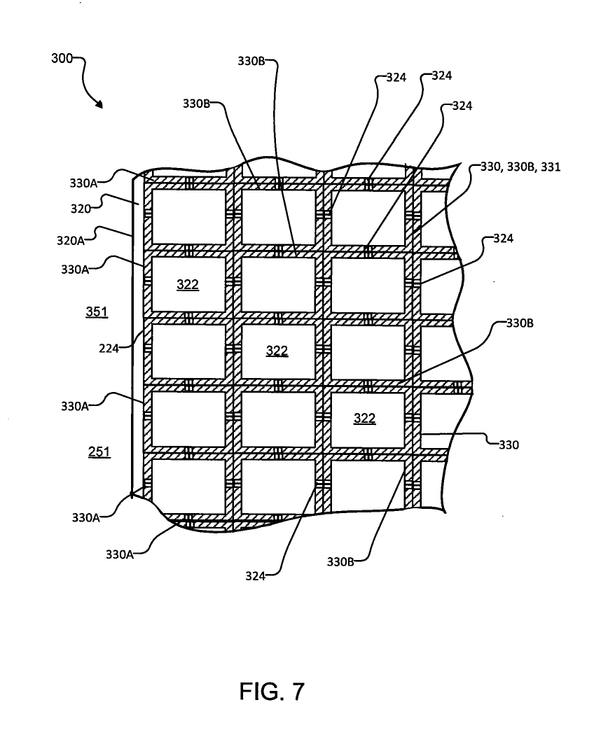

FIG. 7 is a partial plan view of optical component 300 with front plate removed to show the arrangement of spacers 330 according to an example embodiment. In many respects, optical component 300 is similar to optical component 200 described above and similar reference numbers are used to describe similar features, except that the features of optical component 300 are preceded by the numeral “3”, whereas the features of optical component 200 are preceded by the numeral “2”. Optical component 300 differs from optical component 200 primarily in that spacers 330 are closely packed in a manner which eliminates packing spaces. In the particular case of the embodiment illustrated in FIG. 7, spacers 330 (more particularly, their outer surfaces 331) are rectangular in transverse cross-section, but as is well known, spacers 330 could additionally or alternatively be provided with other transverse cross-sectional polygonal shapes that eliminate packing spaces. While, in the case of the illustrated FIG. 7 embodiment, the bore-defining surfaces 333 of spacers 330 are also polygonal in transverse cross-section, this is not necessary and, in some embodiments, the bore-defining surfaces 333 of spacers 330 may have other transverse cross-sectional shapes.

Where spacers 330 are arranged to be closely packed, but without packing spaces (as is the case in the FIG. 7 embodiment), ventilation holes 324 may provide fluid pathways for venting the bores 322 of spacers 330 in which trapped air might otherwise expand and cause unwanted deformation of optical component 300 during the application of heat thereto. More particularly, each spacer 330 of the FIG. 7 embodiment is provided with a plurality (e.g. 4) of spaced apart ventilation holes 324, wherein each ventilation hole 324 is located to provide fluid communication between the bore 322 of the spacer 330 and one or more of: an exterior space 351 (i.e. a space 351 exterior to optical component 300); and a bore 322 of an adjacent spacer 330 (i.e. through the ventilation holes 324 of such adjacent spacers 330).

Like spacers 230 of the FIG. 6 embodiment, spacers 330 of the FIG. 7 embodiment may comprise exterior spacers 330A which are adjacent to exterior space 351 or which are otherwise not surrounded by neighboring spacers 330 and interior spacers 330B which are surrounded by neighboring spacers 330. In some embodiments, exterior spacers 330A comprise a plurality of spaced apart ventilation holes 324, wherein each ventilation hole 324 is located to provide fluid communication between the bore 322 of the exterior spacer 330A and one or more of: exterior space 351; and the bore 322 of an adjacent spacer 330. In some embodiments, each of exterior spacers 330A comprises at least one ventilation hole 324 which is located to provide fluid communication between the bore 322 of the exterior spacer 330A and exterior space 351. In some embodiments, at least one of exterior spacers 330A comprises at least one ventilation hole 324 which is located to provide fluid communication between the bore 322 of the at least one exterior spacer 330A and exterior space 351. In some embodiments, interior spacers 330B comprise a plurality of spaced apart ventilation holes 324, wherein each ventilation hole 324 is located to provide fluid communication between the bore 322 of the interior spacer 330B and the bore 322 of an adjacent spacer 330.

With such an arrangement of spacers 330 and location of ventilation holes 324, optical component 300 of the FIG. 7 embodiment provides a fluid communication pathway or network (e.g. via ventilation holes 324 and via bores 322) for venting the bores 322 of each spacer 330 to exterior space 351.

Unless the context clearly requires otherwise, throughout the description and any accompanying aspects and/or claims:
“comprise,” “comprising,” and the like are to be construed in an inclusive sense, as opposed to an exclusive or exhaustive sense; that is to say, in the sense of “including, but not limited to”.
“connected,” “coupled,” or any variant thereof, means any connection or coupling, either direct or indirect, between two or more elements; the coupling or connection between the elements can be physical, logical, or a combination thereof.
“herein,” “above,” “below,” and words of similar import, when used to describe this specification shall refer to this specification as a whole and not to any particular portions of this specification.
“or,” in reference to a list of two or more items, covers all of the following interpretations of the word: any of the items in the list, all of the items in the list, and any combination of the items in the list.
the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right” , “front”, “back” , “top”, “bottom”, “below”, “above”, “under”, and the like, used in this description and any accompanying aspects and/or claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, component, plate, spacer, etc.) is referred to above, unless otherwise indicated, reference to that component (including a reference to a “means”) should be interpreted as including, as equivalents of that component, any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended aspects and any aspects and/or claims hereafter introduced are interpreted to include all such modifications, permutations, additions, omissions and sub-combinations as may reasonably be inferred. The scope of any aspects and/or claims should not be limited by the preferred embodiments set forth in the examples, but should be given the broadest interpretation consistent with the description as a whole.

What is claimed is:

1. A multi-layer optical component comprising:
a front plate;
a backing plate; and
a plurality of spacers extending between the front plate and the backing plate to maintain a space therebetween, the spacers arranged in a closely packed arrangement where each spacer is in contact with at least one neighboring spacer;
each spacer comprising a bore-defining surface which defines a bore that extends through the spacer and between the front plate and the backing plate; and
each spacer provided with a plurality of spaced apart ventilation holes for providing fluid communication between the bore of the spacer and a location exterior to the bore of the spacer.

2. A multi-layer optical component according to claim 1 wherein, for each spacer, at least one of the plurality of ventilation holes is defined in part by a concavity in a front surface of the spacer and in part by the front plate.

3. A multi-layer optical component according to claim 1 wherein, for each spacer, at least one of the plurality of ventilation holes is defined in part by a concavity in a back surface of the spacer and in part by the backing plate.

4. A multi-layer optical component according to claim 1 wherein, for each spacer, at least one of the plurality of ventilation holes is defined entirely by the spacer.

5. A multi-layer optical component according to claim 1 wherein the spacer is fused to the front plate and to the backing plate.

6. A multi-layer optical component according to claim 1 wherein, for each spacer, an outer surface of the spacer is circular in cross-section.

7. A multi-layer optical component according to claim 1 wherein, for each spacer, an outer surface of the spacer is polygonal in cross-section.

8. A multi-layer optical component according to claim 1 wherein the spacer, the front plate and the backing plate are fabricated from the same material.

9. A multi-layer optical component according to claim 1 wherein the spacers are arranged to provide one or more packing spaces exterior to the bores of the spacers, each packing space defined by outer surfaces of a corresponding plurality of spacers between regions of contact between outer surfaces the corresponding plurality of spacers, by the front plate and by the backing plate.

10. A multi-layer optical component according to claim 9 wherein, for each spacer, at least one of the ventilation holes is located to provide fluid communication between the bore of the spacer and one of the one or more packing spaces.

11. A multi-layer optical component according to claim 9 wherein, for each spacer, at least one of the ventilation holes is located to provide fluid communication between the bore of the spacer and a bore of an adjacent spacer.

12. A multi-layer optical component according to claim 9 wherein, for each spacer, at least one of the ventilation holes is located to provide fluid communication between the bore of the spacer and an exterior of the optical component.

13. A multi-layer optical component according to claim 9 wherein the plurality of spacers comprises: a plurality of interior spacers, each interior spacer transversely surrounded by one or more of: other spacers and packing spaces; and a plurality of exterior spacers, each exterior spacer located transversely adjacent to an exterior of the optical component.

14. A multi-layer optical component according to claim 13 wherein, for each interior spacer, at least one of the ventilation holes is located to provide fluid communication between a bore of the spacer and at least one of: one of the one or more packing spaces; and a bore of an adjacent spacer.

15. A multi-layer optical component according to claim 13 wherein, for each exterior spacer, at least one of the ventilation holes is located to provide fluid communication between a bore of the spacer and at least one of: one of the one or more packing spaces; a bore of an adjacent spacer; and the exterior of the optical component.

16. A multi-layer optical component according to claim 1 wherein the plurality of spacers comprises: a plurality of interior spacers, each interior spacer transversely surrounded by other spacers; and a plurality of exterior spacers, each exterior spacer located transversely adjacent to an exterior of the optical component.

17. A multi-layer optical component according to claim 16 wherein, for each interior spacer, at least one of the ventilation holes is located to provide fluid communication between a bore of the spacer and a bore of an adjacent spacer.

18. A multi-layer optical component according to claim 16 wherein, for each exterior spacer, at least one of the ventilation holes is located to provide fluid communication between a bore of the spacer and at least one of: a bore of an adjacent spacer; and the exterior of the optical component.

19. A multi-layer optical component according to claim 1 wherein the optical component comprises a mirror.

20. A multi-layer optical component according to claim 1 wherein the spacer is attached to the front plate and the backing plate by one or more of: welding and adhesive.

21. A method for fabricating a multi-layer optical component, the method comprising:
providing a front plate;
providing a backing plate;
locating a plurality of spacers to extend between the front plate and the backing plate for maintaining a spacer therebetween;
arranging the spacers in a closely packed arrangement where each spacer is in contact with at least one neighboring spacer;
providing each spacer with a bore that extends through the spacer and between the front plate and the backing plate; and
providing each spacer with a plurality of spaced apart ventilation holes for providing fluid communication between the bore of the spacer and a location exterior to the bore of the spacer.

22. A method according to claim 21 comprising subjecting the front plate, backing plate and spacers to heat to fuse the spacers to the front plate and to the backing plate.

23. A method according to claim 21 comprising molding the optical component to provide at least a portion of the optical component with a desired shape, wherein molding the optical component comprises placing the optical component in contact with a mold and subjecting the optical component to heat.
